(19) United States
(12) Patent Application Publication
(10) Pub. No.: US 2008/0141795 A1
(43) Pub. Date: Jun. 19, 2008

(54) Micro-surface inspection tool

(76) Inventors: Daniel F. Gagnon, Westbrook, ME (US); Robert S. Baker, Harrison, ME (US); Cynthia L. Gagnon, Westbrook, ME (US)

Correspondence Address: BOHAN, MATHERS & ASSOCIATES, LLC, PO BOX 17707, PORTLAND, ME, 04112-8707, US

(21) Appl. No.: 11/638,112

(22) Filed: Dec. 13, 2006

(51) Int. Cl. G01M 19/00

(52) U.S. Cl. 73/865.8

(57) ABSTRACT

Inspection tool for inspecting micro surfaces such as solder joints of electronic components, weld joints, braze joints, machined surfaces, castings, biological samples, crystals, molded components, fibers, wear analysis, finishes, coatings, and the like, under ambient light conditions. The inspection tool has a low lux video camera mounted on the end of a tool holder. Use of a prism is optional. The inspection tool eliminates the need for external front and/or back lighting when inspecting micro surfaces in low-light conditions. The prism enables simultaneous viewing of objects and surfaces in the direct line of view of the camera lens and at an angle.

### BACKGROUND INFORMATION

1. Field of the Invention

The invention relates to a device for visual inspection of micro-surfaces. More particularly, this invention relates to a device for visually inspecting solder connections for microelectronic components, weld joints, braze joints, machined surfaces, castings, biological samples, crystal structures, molded components, fibers, wear analysis, finishes and coatings.

2. Description of the Prior Art

A ball grid array (BGA) is a chip package that is assembled on a printed circuit board (PCB). Conductive metal spheres (balls), arranged in a grid pattern on the underside of the BGA, form the electrical connections between the electronic components on the BGA and the PCB. The BGA is placed on the PCB, the pads of which have been coated with solder paste, and then heated to the point where the solder paste becomes semi-liquid. The board is then cooled, at which point the solder forms rigid current-conducting connections between the various components on the chip package and the PCB.

Many features or characteristics of the ball grid array, such as ball dimensions, count, position, diameter, and body shape are inspected, in order to ensure that bridging between balls or other faults that result in a failed or faulty electrical connection are not likely to occur. The solder joints are difficult to inspect because they are located between the chip package substrate and the PCB, where they are partially obscured from direct viewing and where ambient light is obscured by the BGA itself.

Conventional tools for inspecting sphere shaped solder joints are known. Typically additional lighting is used to illuminate the area to be inspected with front and back lighting. In the present art, cameras used for inspection are high-lux, expensive, bulky, and also require additional lighting. The additional lighting adds to the cost and bulk of the tool, and also adds to the difficulties of inspecting the solder joints. The solder joints are silver and reflect the light. This causes an over-bright spot that can obscure surface details on the joints. Furthermore, additional lighting devices may be burdensome, because it is not always possible to aim the light directly into the area between the BGA substrate and the PCB. Current handheld video micro inspection units weigh in excess of 2 pounds, with a prism that is mechanically unprotected. It is difficult to hold this type of unit manually in a vertical orientation in close proximity to a printed circuit board, particularly without touching the board. Typically, the narrow edge of the prism rests on the PCB, whereby tremendous pressure is exerted on it, pressures on the order of 80,000 psi. The result is that the prism frequently fractures or shatters. In an effort to overcome these disadvantages, other inspection devices have been developed that rely on the use of x-rays to inspect joints. These devices are costly and difficult to use, because of the precautions required when working with x-ray technology.

What is needed, therefore, is a tool for inspecting microelectronic components and assemblies, particularly solder joints on BGAs, that is easy to use, light weight, inexpensive, and enables close inspection of micro-surfaces. What is further needed is such a tool that requires only minimal ambient light.

### BRIEF SUMMARY OF THE INVENTION

The present invention is an inspection tool that inspects a miniature or microscopic object under ambient light, and simultaneously provides a view of the object from two different angles. The inspection tool is particularly useful for inspecting microelectronic components and connections, but is also suitable for close inspection of myriad types of objects, surfaces, spaces, etc., particularly in poorly illuminated environments.

The inspection tool according to the invention comprises a low-lux video camera and a data transmission means for transmitting data to a visual display device. The low lux sensitivity of the camera allows the inspector or operator to view microelectronic components and connections in ambient light, even when the ambient light is poor. The inspection tool according to the invention eliminates the need for an external light source to provide back and/or front lighting of the object being inspected. The low-lux video camera also works with the near-infrared (NIR) spectrum and is able to provide images for detailed viewing that are not possible with standard inspection-tool cameras.

The images projected onto the image sensor of the camera are transmitted via a data transfer cable or wireless transmission to a visual display device, which presents the images in greatly magnified dimensions for easy viewing and inspection. The degree of magnification is determined by the size and resolution of the visual display device.

The inspection tool is, for most applications, a handheld tool that the operator maneuvers to view particular objects. For this purpose, a housing for the inspection tool is formed as a holder or gripper, that is easily held in the hand and light enough to be readily maneuverable. Depending on the intended use of the inspection tool, a prism may be mounted on the tool to allow the camera to capture an image that is at some predetermined angle relative to the focal axis of the camera lens. This ability to view the object from two angles increases the reliability of the inspection. It is within the scope of this invention, however, to encompass an inspection tool that is mounted in a fixture and manipulated by software-controlled location means, so that the operator is viewing the images on the display, but is not manually manipulating the tool.

A particularly well-suited use of the inspection tool according to the invention is to inspect the integrity of solder joints on an assembled PCB. A primary example is the inspection of sphere shaped solder joints on a BGA. These solder joints form a grid between the BGA and the PCB and provide the electrical connection between components on the BGA with components or conductors on the PCB. The purpose of inspection is to ascertain that the shape and surface of the joints are properly formed and dimensioned, that no bridges have formed between adjacent joints, and that other faults are not present. The operator maneuvers the inspection tool such that the objects to be inspected are presented on the visual display device. Objects that are in shadow or are in poorly illuminated areas are clearly imaged by the low-lux video camera and appear clearly on the visual display device.

### BRIEF DESCRIPTION OF THE DRAWINGS

The present invention is described with reference to the accompanying drawings. In the drawings, like reference numbers indicate identical or functionally similar elements. The drawings are not necessarily drawn to scale.

FIG. 1 is side planar view of the inspection tool according to the invention.

FIG. 2 is a block diagram of an inspection system.

FIG. 3 illustrates the inspection tool of FIG. 1, being used to inspect a BGA.

FIG. 4 illustrates two views being imaged simultaneously.

FIG. 5 shows the two views as presented on the visual display device.

### DETAILED DESCRIPTION OF THE INVENTION

The present invention will now be described in detail with reference to the accompanying drawings, in which the preferred embodiments of the invention are shown. This invention should not, however, be construed as limited to the embodiments set forth herein; rather, they are provided so that this disclosure will be complete and will fully convey the scope of the invention to those skilled in the art.

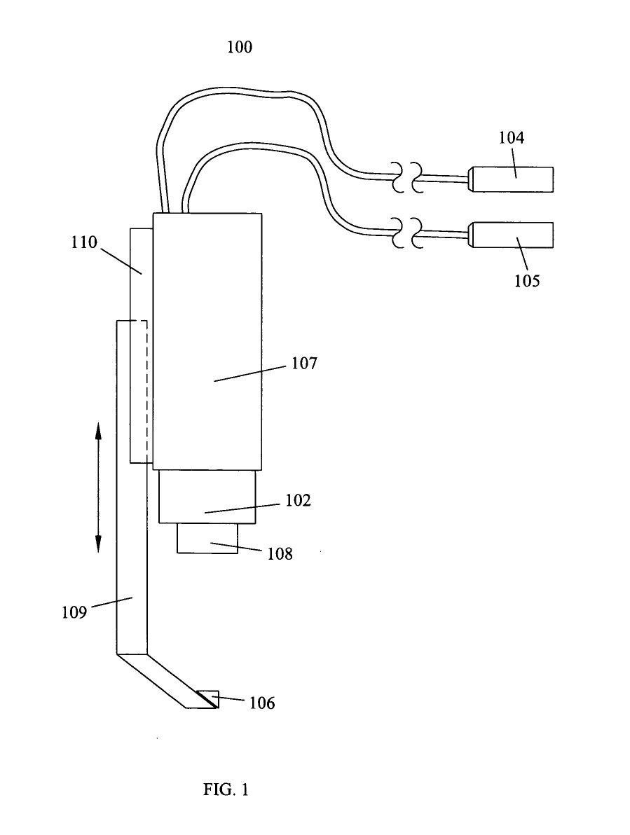

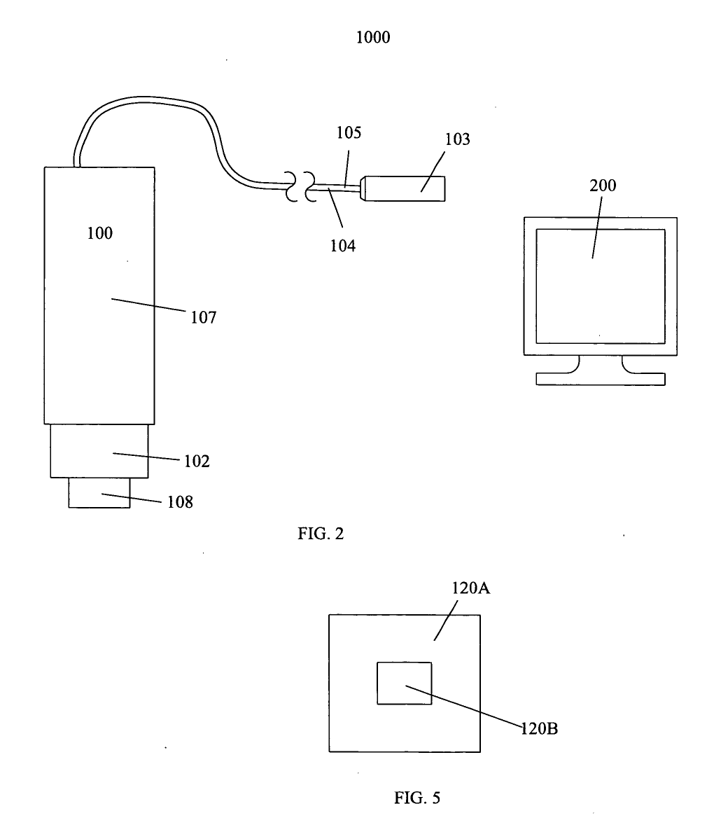

FIG. 1 illustrates an inspection tool 100 and FIG. 2 an inspection system 1000 according to the invention. The inspection tool 100 comprises a low-lux video camera 102, with a lens 108 mounted on the end of a tool holder 107, a power source 104, a data transmission means 105, and, optionally, a prism 106. The camera 102 is an extremely sensitive low lux video/digital camera or the like requiring only 0.05 lux or less at F-stop 2.0 for visual inspection. An example of a suitable camera is the SONY KPC S20 series miniature square camera. The lens is ideally an adjustable-focus lens. The embodiment of the inspection tool 100 shown in FIG. 1 is one intended to be held by hand and manipulated by the operator. To this end, the tool holder 107 is constructed of material and in a shape that lends itself to being held and manipulated by hand. The camera 102 is assembled at the end of the tool holder 107. The inspection system 1000 as shown in FIG. 2 comprises the inspection tool 100 and a visual display device 200. In the embodiment shown, the power source 104 and the data transmission means 105 are combined in a single cable having a USB connector 103, which is connectible to the visual display device 200. The visual display device 200 is a conventional video monitor or a computing device, such as, a PDA, computer, etc., and provides the power to operate the camera 102. It is also within the scope of the invention to provide separate cables, a power source cable that connects to a conventional AC power source, and a data transmission cable that connects to the visual display device. The inspection tool 100 may also be configured as a wireless device, wherein the data transmission means 105 is a transmitter that transmits image data captured by the camera 102 to the visual display device 200 using RF, infrared, sonic, or other suitable wireless transmission technology. The power source 104 for the camera may be provided by a conventional battery pack.

FIG. 3 is a magnified view of the working end of the inspection tool 100, being used to inspect a ball grid array BGA. Each solder ball SB in the BGA has a first solder joint SJ1 and a second solder joint SJ2, each of which provides an electrical conductor between a first electronic component C1 and a second electronic component C2. The distance between the first and second electronic components C1 and C2 in a PCB assembly is only approximately 0.020 inches high and, because of this, the solder joints SJ1 and SJ2 are obscured from view and poorly illuminated. The prism 106, disposed in the optical axis 113 of the camera 102 presents an image to the camera 102 that is at some angle to the optical axis 113 of the camera. In the embodiment shown, the prism 106 is mounted on the end of a prism arm 109. In the embodiment shown, the prism 106 is a 90-degree refraction prism that presents an image to the camera 102 that is oriented 90-degrees to the optical axis. This allows the operator to view into the ball grid space between the first and second electronic components C1 and C2. The prism arm 109 is preferably adjustably mounted on the housing of the tool holder 107, to allow the distance between the prism 106 and the camera 102 to be adjusted, as needed. In the embodiment shown, the prism arm 109 is slidably retained within a track 110, as shown in FIG. 1, although other methods of mounting the prism 106 are included within the scope of the invention. Depending on the particular application of the inspection tool 100, it may be desirable to alternate between use of the camera 102 with and without the prism 106. To this end, the prism arm 109 may also be rotatably mounted on the tool holder 107, such that it may be swung out of the way, or be mounted by some means of a friction-fit, a snap fit, a twist quick-coupler, or other type of quick coupling, such that it is quickly and easily removed.

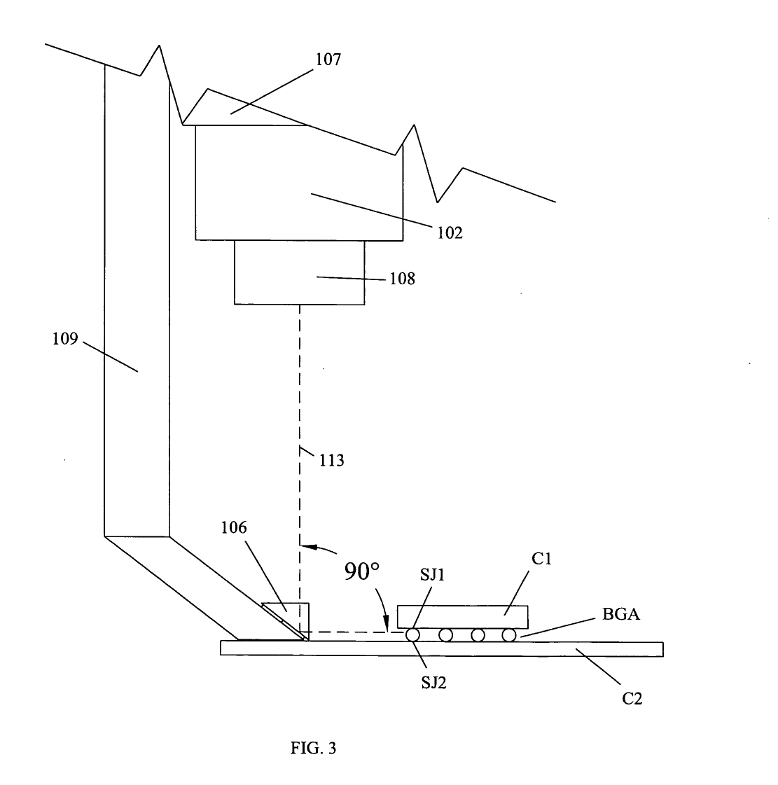

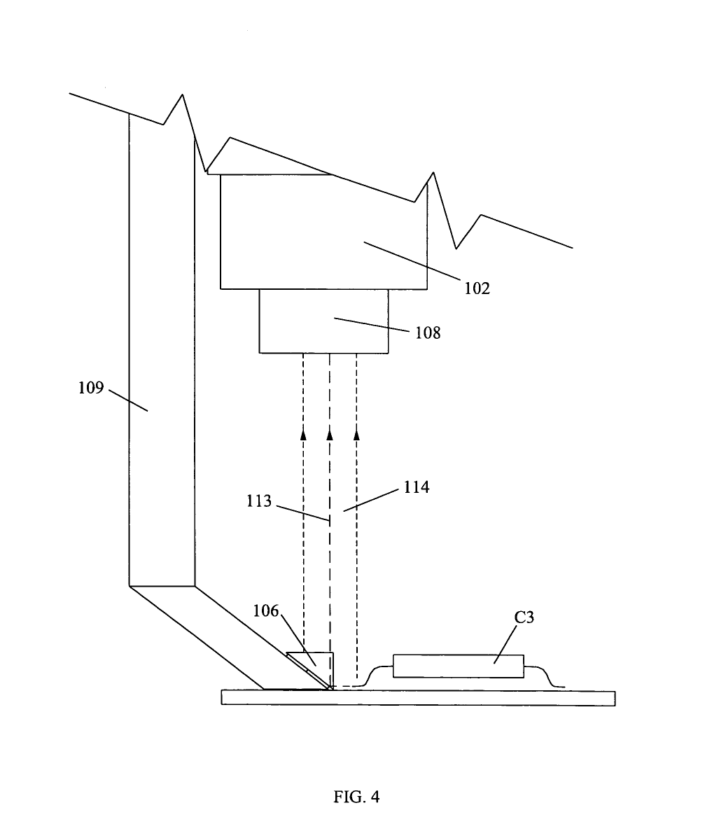

FIGS. 4 and 5 illustrate simultaneous double-viewing of an image, using the inspection tool 100 with prism 106. The field of view 114 of the camera is concentric about the optical axis 113 and captures an image in a plane that is orthogonal to the optical axis. The prism 106 captures a much smaller image in a plane that is parallel to the optical axis 113, for example, depending on the angle of the prism used. The operator is now able to view simultaneously a first image 120A that corresponds to the image captured in the orthogonal plane and a second image 120B captured in the parallel plane. This inspection allows for faster, easier and more reliable information for surfaces and surface joints, such as, for example, leaded electronic components C3, on which it is useful to be able to view several features or faces of the component simultaneously.

The camera 102 is capable of capturing images in the normally visible range, as well as in the Near-Infrared (NIR) spectrum. This enables the operator to use the inspection tool 100 without having to provide external or additional sources of illumination, which is particularly desirable when inspecting components that are reflective. The solder balls SB, for example, are silver and, as such, reflect light, which appears on the captured image as a bright spot. This bright spot washes out or obscures some of the features on the surface of the solder ball SB, and, particularly, may obscure a close view of the solder joints SJ1 and SJ2. Much greater detail on the solder joints SJ1 and SJ2 is actually visible when the area to be inspected is not brightly illuminated, but is, instead, dimmed. Small details, paint chips, etc. are more readily visible in a dimmed environment. The inspection tool 100 according to the invention is able to capture images using only light in the NIR range, thereby providing the operator with more information on the important features of the solder joint and improving the reliability of the inspection. The elimination of any external or additional light sources reduces the cost of the inspection setup. It also makes the setup less bulky and allows greater maneuverability of the tool.

It is understood that the inspection tool 100 according to the invention may be mounted in a fixture that is manually or automatically controlled to scan a particular object. The operator, viewing the images presented on the video monitor, is able to interrupt the automatic scanning process and review or record the image.

It is understood that the embodiments described herein are merely illustrative of the present invention. Variations in the construction of the inspection tool may be contemplated by one skilled in the art without limiting the intended scope of the invention herein disclosed and as defined by the following claims.

What is claimed is:

1. An inspection tool comprising:
a camera mounted in a tool holder, said camera having a low-lux sensitive image sensor for capturing image data;
a data transmission means for transmitting data from said camera to a visual display device; and
a power source for energizing said camera.

2. The inspection tool of claim 1, wherein said data transmission means includes a cable that transmits said image data captured by said camera to said visual display device.

3. The inspection tool of claim 2, wherein said cable has a USB connector and provides said power source for energizing said camera.

4. The inspection tool of claim 1, wherein said data transmission means includes a wireless transmitter that broadcasts said image data to said visual display device.

5. The inspection tool of claim 4, wherein said data transmission means is an RF transmitter.

6. The inspection tool of claim 4, wherein said data transmission means is an infrared transmitter.

7. The inspection tool of claim 4, wherein said data transmission means is a sonic transmitter.

8. The inspection tool of claim 1, wherein said power source is a power cable.

9. The inspection tool of claim 1, wherein said power source is a battery pack.

10. The inspection tool of claim 1 further comprising a prism, wherein said camera has an optical axis and said prism presents an image to said camera that is at an angle relative to said optical axis.

11. The inspection tool of claim 10, wherein said prism is a 90-degree refraction prism.

12. An inspection system comprising:
an inspection tool, a visual display device, a data transmission means, and a power source;
wherein said inspection tool comprises a camera mounted in a tool holder, said camera having a low-lux image sensor; and
wherein said data transmission means transmits data from said image sensor to said visual display device.

13. The inspection system of claim 12, wherein said data transmission means is a cable that transmits data from said image sensor to said visual display device.

14. The inspection system of claim 12, wherein said data transmission means includes a wireless data transmitter that transmits data from said image sensor to said visual display device.

15. The inspection system of claim 14, wherein said wireless data transmitter is an RF transmitter.

16. The inspection system of claim 14, wherein said wireless data transmitter is an infrared transmitter.

17. The inspection system of claim 14, wherein said wireless data transmitter is a sonic transmitter.

18. The inspection system of claim 12, wherein said power source is a power cable.

19. The inspection system of claim 12, wherein said power source is a battery pack.
